(19) United States
(12) Patent Application Publication
(10) Pub. No.: US 2016/0331071 A1
(43) Pub. Date: Nov. 17, 2016

(54) SYSTEMS AND METHODS FOR MAKING CUSTOM ORTHOTICS

(71) Applicant: FOOT INNOVATIONS, LLC, Coatesville, PA (US)

(72) Inventors: Justin M. KANE, Coatesville, PA (US); Bum-Joon JUNG, Seoul (KR); Michael KAJON, New York, NY (US); Wasila MANSOURI, Troy, NY (US); Joseph Nicholas MITCHELL, Tuxedo Park, NY (US); Magdalena Rose PRENTICE, Carlisle, MA (US); George L. QU, Stamford, CT (US); Eric Howard LEDET, Guilderland, NY (US)

(21) Appl. No.: 15/155,786

(22) Filed: May 16, 2016

Related U.S. Application Data
(60) Provisional application No. 62/161,682, filed on May 14, 2015.

(51) Int. Cl. A43B 7/28; G01L 5/00; G01B 21/02

(52) U.S. Cl. CPC A43B 7/28; G01B 21/02; G01L 5/00; B29C 67/0055

(57) ABSTRACT

A method of manufacturing a custom foot orthotic for a patient is described. The method includes collecting dynamic pressure data of a plantar surface of the foot of the patient at multiple time frames during a gait cycle of the patient, determining the dimensions of the patient's foot from the dynamic pressure data, scaling a three dimensional model of a foot orthotic along the x and y axes to form a scaled three dimensional model which approximates the dimensions of the patient's foot and adjusting the height of the scaled model along the z-axis in one or more regions based on the dynamic pressure data to form a three-dimensional model of the custom foot orthotic. A method is also provided which includes creating a two-dimensional model of a custom foot orthotic from dynamic pressure data and extruding the two-dimensional model in one or more regions based on the dynamic pressure data to form a three-dimensional model of the custom foot orthotic. The orthotic can be manufactured using 3D printing. Systems for manufacturing a custom foot orthotic are also provided.

### CROSS REFERENCE TO RELATED APPLICATIONS

This application claims the benefit of Provisional U.S. Patent Application Ser. No. 62/161,682, filed May 14, 2015, pending, which is incorporated by reference herein in its entirety.

### BACKGROUND

1. Field

This application relates generally to systems and methods for making custom orthotics and, in particular, to systems and methods for making custom foot orthotics.

2. Background of the Technology

Foot pain is a common issue both in the United States and in the world, with about 77% of Americans having experienced some type of foot pain in their life [1]. Structural deformities in the foot can have serious implications on daily activities and lifestyle. About 50% of the adult population in the United States experience restrictions in activities such as exercising, working, and walking due to foot pain [1].

Diabetes is a metabolic disorder affecting more than 131 million people worldwide that commonly leads to loss of sensation, or neuropathy, in the lower extremities [2]. Diabetics have a 25% risk of developing foot ulcers from repeated loading of high pressure points that result from structural deformities in the foot [2]. Foot ulcers progress over time with loading, and failure to treat these pathologies can lead to adverse complications. With about 80% of diabetic ulcers leading to amputation, it is important to address the structural and biomechanical changes in pathological feet to both stop the progression and prevent the occurrence of the pathology.

Orthotics are common treatments used to offer pain relief and stabilize foot deformities, restrict unnecessary motion of the foot and ankle, and relieve areas of excessive pressure [3]. The proper fitting of orthotics is essential because ill-fitting footwear can further introduce deformities in the foot [4].

The human foot is a complex anatomic structure consisting of 26 bones, 33 joints, 19 muscles, and 107 ligaments that allow for everyday movements such as walking and running. The bones in the feet are constructed in such a way that arches are formed in the midsection of each foot. These arches help support the feet and are the main method for weight distribution during gait. The fore foot is the front of the foot which consists of the phalanges and the metatarsals. The metatarsals interlock with the cuneiform bones, cuboid bone, and the navicular bone, which are located in the middle of the foot, in order to form a medial and longitudinal arch that ends at the calcaneus. The hind foot is where the calcaneus and the talus bones connect with the fibula and the tibia to form the ankle.

The normal medial longitudinal arch is 15 to 18 mm from the ground at the level of the navicular, which is the keystone of the arch, whereas the lower lateral longitudinal arch is normally 3 to 5 mm from the ground at the level of the cuboid [5]. Within a normal transverse arch, the angle formed between the metatarsal and the ground in the sagittal plane is 18 to 25 degrees; and 15 degrees, 10 degrees, 8 degrees, and 5 degrees from toes 1 to 5 (medial to lateral) respectively, as seen in FIG. 2 [5]. The arches of the feet help support the body weight and protect the nerves and vascular supply which runs through the plantar aspect of the foot. The shape of the arches within the foot provides structural stability and proper weight distribution while in gait.

Pathophysiology in the foot that results from structural deformities can lead to serious implications, such as inability to do normal activities like walking and running. Flat foot is a frequent problem in both children and adults and presents itself as a lowering of the medial foot and plantar arch [2]. Flat foot can produce severe pain and disability if left untreated [6]. Flat foot occurs when the arch of the midfoot has completely flattened, which results in an uneven distribution of weight. Patients suffering from flat foot develop pains when they are in motion and often require an orthotic to help correct for deformities. An increase in the arch-flattening effects of the triceps surae or an increase in the weight of the body will tend to flatten the arch [7]. Weakness of the muscular, ligamentous, or bony arch supporting structures will lead to collapse of the arch [7]. As a result of flat foot pathophysiology, the ankle becomes shifted towards the inner section of the foot, placing weight in the medial edge of the foot, as compared to the normal foot position when the person is standing under static conditions [8].

Due to uneven weight distribution, many patients who suffer from flat foot tend to apply all the pressure on their calcaneus and the inner side of the foot during gait. This also affects foot posture when the patient is standing still, because a patient with flat foot will have his or her ankles pronated. In order to correct this pathology, the foot needs to rebalance the forces that act on the arch so it can improve function and lessen the chance for further or subsequent development of deformity [7]. Flat foot is a result of deformities in the structure of the foot which creates an uneven loading of body weight that often leads to foot pains. In order to fix this pathophysiology, an orthotic can be created that can help redistribute the pressure by recreating the arches with wedges to the midfoot.

There are currently two types of custom orthotics being used to treat pathophysiology of the feet. Accommodative orthotics are made of soft flexible materials, usually ethylene-vinyl acetate (EVA), with the goal of cushioning any deformations in the foot. Functional orthotics are made to control the mechanics of the foot and are generally made out of more rigid materials like high density polypropylene [7]. Functional orthotics are used to hold the foot in a therapeutic position, while controlling joint movement [9].

Currently, most custom orthotics are made using a static impression or pressure map of a patient's feet. When the foot is static, the pressure of the body is distributed across the calcaneus and the metatarsals. When the foot is dynamic, the pressure is more localized, and moves from the calcaneus to the lateral arch, then to the outer metatarsals, and finally to the toes and the hallux, in one long rolling motion. One form of gait classification lists this process in six phases: heel strike, foot flat, mid-stance, heel-off, toe-off, and finally mid-swing [5]. Because the shape of the foot changes when a patient is walking, as opposed to standing still, custom orthotics are often reported to be uncomfortable, and multiple iterations have to be made, which takes time and money. Additionally, current static techniques for custom orthotics involve free-hand fabrication of the orthotic. This introduces a degree of variability when acquiring measurements from the plantar surface of a patient's foot [9].

In current orthotic techniques, the variance introduced when acquiring measurements along with free-hand fabrication of the products offer little consistency between product iterations. The multifaceted problem is that there is insufficient data describing what is normal for foot physiology, therefore there are no data to compare the corrected pathological foot to, in an automated fabrication process. The incorporation of these data would lead to a more consistent, reliable product.

Orthotic devices are a major segment of the orthotic and prosthetic market, accounting for about 70% of the global orthotic and prosthetics market [10]. The United States, Europe, and Japan are responsible for the majority of the global orthotic device market, with the United States making up the largest market contributions [11]. With more than 200 million Europeans experiencing disabling foot and ankle conditions, the European market is a major contributor in the orthotic device market [12]. European costs to treat foot and ankle conditions with supportive and corrective orthotic devices accumulate to over 330 million dollars per year [12].

Expected projections for the orthotic and prosthetic market include significant growths in the global market due to the increase for demand in supportive and corrective orthotic devices. The demand for orthotics can be attributed to the growing elderly populations in the world and an increasingly active population, resulting in a need for supportive active footwear and orthotics [13]. Advancement in material technology has introduced methods for better fabrication of orthotics, providing more customization of this device for specific needs. The disposability of the orthotic devices contributes to the demand for orthotic devices. Orthotic devices have a limited lifetime of 1-3 years, resulting in the need to periodically replace them [11].

According to the Global Orthotic Devices Market Report, major orthotic device product launches between 2013 and 2014 focused on product features of comfort, durability, and cost-effectiveness of the device. In 2013, major competitors in the global orthotic market included international companies DJO Global Inc., Otto Bock Holding GmbH& Co.kg, Ossurhf, DeRoyal Industries Inc., and Bauerfeind AG [14]. Glasgow Caledonian University (GCU), a university in Scotland, UK, is using 3D technology to manufacture custom orthotics [12, 14, 15, 16].

With a large global demand for custom foot orthotic devices, there exists a need to optimize the current production process of customized orthotics.

### SUMMARY

A method of manufacturing a custom foot orthotic for a patient is provided which comprises:

collecting dynamic pressure data of a plantar surface of the foot of the patient, wherein the dynamic pressure data includes pressure data taken at multiple time frames during a gait cycle of the patient;

creating a three-dimensional model of a foot orthotic, wherein the foot orthotic has a length, a width and a height and wherein the three-dimensional model comprises an x-axis extending along the length of the foot orthotic, a y-axis perpendicular to the x-axis and extending along the width of the foot orthotic and a z-axis perpendicular to the plane formed by the x and y axes and extending along a thickness of the foot orthotic;

determining the dimensions of the patient's foot from the dynamic pressure data;

scaling the three dimensional model along the x and y axes to form a scaled three dimensional model which approximates the dimensions of the patient's foot; and

adjusting the height of the scaled model along the z-axis in one or more regions based on the dynamic pressure data to form a three-dimensional model of the custom foot orthotic.

A method of manufacturing a custom foot orthotic for a patient is also provided which comprises:

collecting dynamic pressure data of a plantar surface of the foot of the patient, wherein the dynamic pressure data includes pressure data taken at multiple time frames during a gait cycle of the patient;

creating a two-dimensional model of the custom foot orthotic from the dynamic pressure data, wherein the foot orthotic has a length, a width and a height and wherein the two-dimensional model comprises an x-axis extending along the length of the foot orthotic and a y-axis perpendicular to the x-axis and extending along the width of the foot orthotic;

converting the two-dimensional model into a three dimensional model by extruding one or more regions of the two-dimensional model along a z-axis perpendicular to the plane formed by the x and y axes and extending along a thickness of the foot orthotic based on the dynamic pressure data to form a three-dimensional model of the custom foot orthotic.

A system for manufacturing a custom foot orthotic for a patient is also provided which comprises:

a pressure mat adapted to measure dynamic pressure of a plantar surface of a foot of the patient, wherein the dynamic pressure data includes pressure data taken at multiple time frames during a gait cycle of the patient; and

a computer adapted to:

access a three dimensional model of a foot orthotic, wherein the foot orthotic has a length, a width and a height and wherein the three-dimensional model comprises an x-axis extending along the length of the foot orthotic, a y-axis perpendicular to the x-axis and extending along the width of the foot orthotic and a z-axis perpendicular to the plane formed by the x and y axes and extending along a thickness of the foot orthotic;

determine the dimensions of the patient's foot from the dynamic pressure data;

scale the three dimensional model of the foot orthotic along the x and y axes to form a scaled three dimensional model which approximates the dimensions of the patient's foot; and

adjust the height of the scaled model along the z-axis in one or more regions.

A system for manufacturing a custom foot orthotic for a patient is also provided which comprises:

a pressure mat adapted to measure dynamic pressure of a plantar surface of a foot of the patient, wherein the dynamic pressure data includes pressure data taken at multiple time frames during a gait cycle of the patient; and

a computer adapted to:
collect dynamic pressure data from the pressure mat, generate a two-dimensional model of a foot orthotic from the pressure data, wherein the foot orthotic has a length, a width and a height and wherein the two-dimensional model comprises an x-axis extending along the length of the foot orthotic and a y-axis perpendicular to the x-axis and extending along the width of the foot orthotic;
convert the two-dimensional model into a three dimensional model by extruding one or more regions of the two-dimensional model along a z-axis perpendicular to the plane formed by the x and y axes and extending along a thickness of the foot orthotic based on the dynamic pressure data to form a three-dimensional model of the custom foot orthotic.

These and other features of the present teachings are set forth herein.

### BRIEF DESCRIPTION OF THE DRAWINGS

The skilled artisan will understand that the drawings, described below, are for illustration purposes only. The drawings are not intended to limit the scope of the present teachings in any way.

FIG. 1 is a schematic showing a 3D model of a scanned orthotic created using a solid modeling computer-aided design (CAD) and computer-aided engineering (CAE) computer program.

FIG. 2 is a schematic representation of a 3D model of a generic orthotic that can be imported from 3D modeling system into coding software wherein the orthotic is represented as a series of points plotted in an x-, y-, and z-axis.

FIG. 3 is a schematic representation of a graphical user interface (GUI) created in coding software that GUI includes (from left to right): a pressure map data taken from the pressure mat with options of looking at the heel, midfoot, forefoot, toe, or an overlay of all the data; a top down view of the orthotic with the selected section highlighted (selections will include, but are not limited to: heel, midfoot, forefoot, and toe); and a side view of the orthotic for visualizing the amount of extrusion occurring, along with a suggested extrusion amount based on calculations done in a coding software.

FIG. 4 is a 3D solid model of the orthotic scanned into modeling software, wherein the solid model shows rough surface details transferred into the model from the physical orthotic.

FIG. 5A shows data transferred from coding software into 3-D modeling software which appears in the 3-D modeling software as points in 3-D space.

FIG. 5B shows the data from FIG. 5A meshed into a solid model by connecting the data points to form the solid model.

FIG. 6 is a schematic showing a solid model of an orthotic wherein the model is divided into four basic shapes to allow a user to modify the model to fit a patient.

### DETAILED DESCRIPTION

As used herein, “heel strike” is defined as the stage of a human walking gait which starts the moment when the heel first touches the ground, and lasts until the whole foot is on the ground (mid-stance stage).

As used herein, “mid-stance” is defined as the stage of a human walking gait wherein the whole foot is on the ground. The end of the “mid-stance” stage occurs when the body's center of gravity passes over the top of the foot. The body's center of gravity is located approximately in the pelvic area in front of the lower spine during standing and walking.

As used herein, “heel-off” is defined as the stage of a human walking gait after the body's center of gravity has passed in front of the neutral position (i.e., over top of the foot). The “heel-off” stage of gait ends when the heel lifts off the ground.

As used herein, “heel-off” is defined as the stage of a human walking gait which begins when the heel begins to leave the ground.

According to some embodiments, systems and methods for 3-dimensional modeling and printing of orthotics are provided. According to some embodiments, systems and methods for fitting a patient with an orthotic device used to redistribute the patient's weight are provided. According to some embodiments, the method comprises taking initial foot pressure readings from the patient using, for example, a pedobarograph, transmitting the pressure data to a computer and/or smart device (e.g., wirelessly) and using the pressure data to form a custom orthotic. The data can be immediately sent to a 3-D printer for manufacturing a custom orthosis on-site or the data can be forwarded offsite for the manufacture of the custom orthosis. Foot pressure readings can also be taken after the patient has been fitted with the orthotic to determine the effectiveness of the orthotic.

By taking dynamic measurements of the foot, the structural differences of the foot during gait will be accounted for. The data collected from the dynamic foot measurements can be transferred into 3-D modeling software that can adapt to and fix the problem computationally. The model can be verified using data collected from several normal patients. Using the 3-D model, an automated system can 3-D print or otherwise generate an orthotic device, eliminating the variance introduced by artisan labor.

A custom orthotic system is provided that uses a dynamic pressure map of a patient's feet to produce a personalized orthotic shoe insert that is comfortable and cost-efficient. The use of a computer software system to assign orthotic dimensions, driven by user input, can improve consistency in orthotic production, thus eliminating the sources of variation introduced in methods that are currently used. The product can then be fabricated using an automated manufacturing technique to reduce time of orthotic fabrication.

The method described herein provides a more rapid and lower cost method for manufacturing custom orthotics. Currently, custom orthotics sell for up to $800, while the manufacturing cost is about $80 [17]. Because the manufacturing system is automated there are reduced labor costs, so total marginal costs to produce a pair of orthotics can be less than $50. Marginal costs include the energy required to operate any machines, labor, and the costs of the material. The time for production of one pair of orthotics starts at data collection, and includes data analysis, data manipulation, manufacturing, and post processing. According to some embodiments, the total time for production using this process can be less than 5 days. According to some embodiments, the total time for production using this process can be less than 24 hours.

The method described herein is more standardized than current methods used for manufacturing custom orthotics. By using the method described herein, errors introduced during the orthotic measurement and fabrication processes can be reduced.

According to some embodiments, the system uses data recorded by a pressure mat system. According to some embodiments, data received from the pressure mat can be input into a software interface which analyzes the data and, based on the data, design an orthotic to correct for the abnormalities of the patient's feet. According to some embodiments, the orthotic model can then be output to a file type that can be recognized by an automated manufacturing process (e.g., .stl file) to allow for automated fabrication of the final orthotic.

The process for manufacturing the orthotic can be categorized into three major sub-systems: data collection, data processing, and product manufacturing. Each sub-system is described in detail below.

According to some embodiments, data collection comprises capturing dynamic pressure measurements of the foot's plantar surface during a patient's gait. There are several measurements that can be recorded using the data collection subsystem.

According to some embodiments, the dynamic pressure measuring device has sufficient resolution for correcting foot pathologies. For example, a system is provided having at least 1.4 sensors per cm². The dynamic pressure measuring device then transmits data to a computer to allow for real-time visualization. The interface between the dynamic pressure measuring device and the computer can be USB, wireless (e.g., WiFi) or any other acceptable form of communication. The dynamic pressure measuring device can be powered by USB, or by another power source such as an external wall outlet (e.g., 120 V).

According to some embodiments, the dynamic pressure measuring device can measure and record real-time pressure distributions of the plantar surface of the foot. The range of pressures accepted should accommodate the large majority of patients (e.g., 10-500 kPa).

Calibration and precision should remain constant within these operating parameters for the lifetime of the data collection unit. The system will last at least five years in service, or a minimum of 1500 cycles. Each cycle will consist of an entire patient trial of data collection.

According to some embodiments, the system will accommodate a foot length of up to 32 cm. According to some embodiments, the system is lightweight. For example, the system can have a mass of a maximum of 5 kg in order to be easily moved and stored.

According to some embodiments, the system includes a foot outline to guide the patient.

According to some embodiments, the system is less than 3 cm tall to avoid tripping and gait changes. According to some embodiments, all electronic componentry are contained within the device, other than the USB connection (if necessary) or power cord (if necessary). According to some embodiments, the system can be sanitized using a cleansing solution or product to eliminate the spread of germs between patients.

According to some embodiments, the system can operate from in a temperature range of 18°-35° C., a pressure range of 10-500 kPa, and 40-90% humidity.

According to some embodiments, the system includes a graphical user interface (GUI). The GUI can be simple to use such that the system can be used by someone who has no knowledge of programming. The software receives data from the data collection subsystem, runs an analysis, and outputs a 3-D custom orthotic dimensions to a 3-D modeling program.

Upon collection of data from the patient, a software package will be included to digitally model the 3-D topography of the plantar surface. The software must be able to manipulate the model, implementing industry standard treatment options for the pathology indicated. Finally, the modified model will lead to an orthotic design in a compatible file format that can be used by an automated manufacturing machine to create the physical orthotic.

According to some embodiments, the manufacturing technique can fabricate a product using a material having properties as described below. According to some embodiments, the material has a maximum density of 2.0 g/cm³ so that the original gait cycle is not altered. According to some embodiments, the material has a bulk modulus ranging from 10 MPa to 2 GPa. According to some embodiments, the material does not undergo plastic deformation under loads of 3000 N or less. According to some embodiments, the material is nonporous to ensure that moisture and contaminants are not absorbed.

According to some embodiments, the total time for production is less than 24 hours from the time of data collection through post processing.

The manufacturing technique should accurately and repeatedly produce orthotic inserts according to the processed data with at most one defect per 1000. Because orthotics lack small detailed features, the manufacturing technique only needs to accommodate features as small as 100 μm.

The manufacturing process will occur indoors in a manufacturing facility. Average temperature level must range from 18 to 35 degrees Celsius and humidity level must be range from 40 to 90 percent.

According to some embodiments, the manufacturing system has a maximum build volume that is 32 cm in length, 10 cm in width, and 1 cm in height to accommodate the largest feet. If a 3D printer is used, it must have a building envelope at least this large.

The main design considerations for the data collection hardware are resolution, cost, and ease of use. Commercially available pressure sensing platforms are currently available. TekScan of South Boston, Mass. offers a high resolution mat under (MatScan®) which can be used to accurately measure the pressure distribution of the plantar surface of the foot. TekScan also offers a variety of software options including FootMat™ Software which can be used to provide gait analysis for the patient. The TekScan mat was designed for gait analysis and is therefore optimized to perform under the dynamic pressure monitoring conditions described herein. The mat also has a low profile such that patients will not trip or alter their gait to step on it. The TekScan mat can either be wireless, or interface to a computer via USB. The wireless option only transmits 25 Hz scans, as opposed to 185 Hz scans for the wired option. The TekScan mat can only capture pressure information in a 2D array. Other data collection modalities, such as 3D scanning, can be added.

The data collected from the pressure sensing device can be transferred into coding software, such as MATLAB. The data can be represented as a plot of points in the x-, y-, and z-planes. The pressure data can be taken in real time as the patient walks across the pressure mat. According to some embodiments, four time frames are identified—heel down, midfoot, forefoot, and toe off—and data from each time frame can be exported into a spreadsheet (e.g., Microsoft Excel®). The spreadsheet data can be comprised of a grid of rows and columns (e.g., 88 rows and 96 columns) representing each pressure sensor, and the values of the sensors range from 0 (no pressure) to 256 (maximum pressure). The coding software then imports the spreadsheet data for analysis.

According to some embodiments, manufacture of a custom orthotic includes modifications made by user input to a pre-existing orthotic. According to some embodiments, a 3D model of a generic orthotic in in a 3D CAD design program (e.g., SolidWorks published by Dassault Systèmes of Vélizy-Villacoublay, France) can be imported into software, where the generic orthotic can then be customized to the individual. The user can identify measurements of the orthotic needed for each individual patient. The decisions for the dimensions will be made by the user who will have access to the dynamic pressure data collected from the patient. Through a graphical user interface (GUI), the user can specify the desired value that corresponds to pre-specified regions of the orthotic. For example, the user interface can have a box for input of the desired hind foot post height. The user will specify the desired height of the hind foot post, and the height of the generic orthotic will be adjusted to that corresponding value. Following these modifications, the model will then be imported into a 3D modeling software. The coordinates that make up the altered orthotic, represented as points arranged in a 3D space, can be meshed into a solid model, which can be converted to a file for manufacturing (e.g., an .stl file).

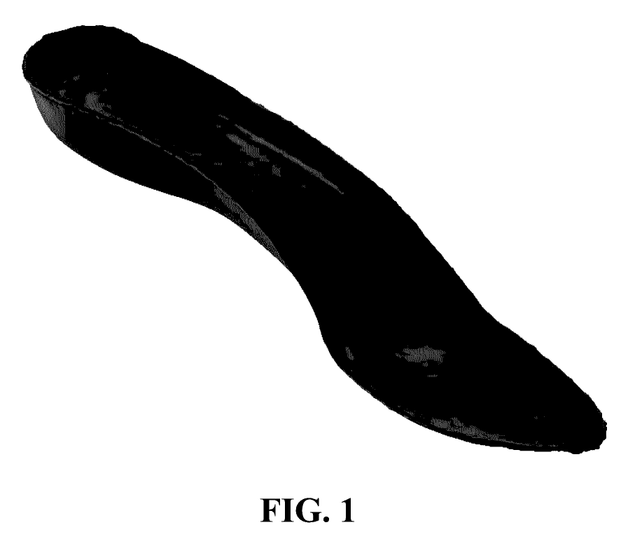

The above described method involves designing a custom orthotic from a pre-existing, generic orthotic. Modifications for specific regions and parameters will be made to the generic orthotic model to make it customized to the individual patient. According to some embodiments, a 3D solid model of a generic orthotic for flatfoot can be scanned into a 3D modeling software using a 3D scanner to capture the major features of the orthotic. The 3D model of a generic flatfoot orthotic is presented in FIG. 1 which is a schematic showing a 3D model of a scanned orthotic created using a solid modeling computer-aided design (CAD) and computer-aided engineering (CAE) computer program (i.e., SolidWorks) using a 3D scanned orthotic. The 3D model can be imported into a coding software. Modifications to the generic orthotic can be used to produce a customized orthotic for individual production.

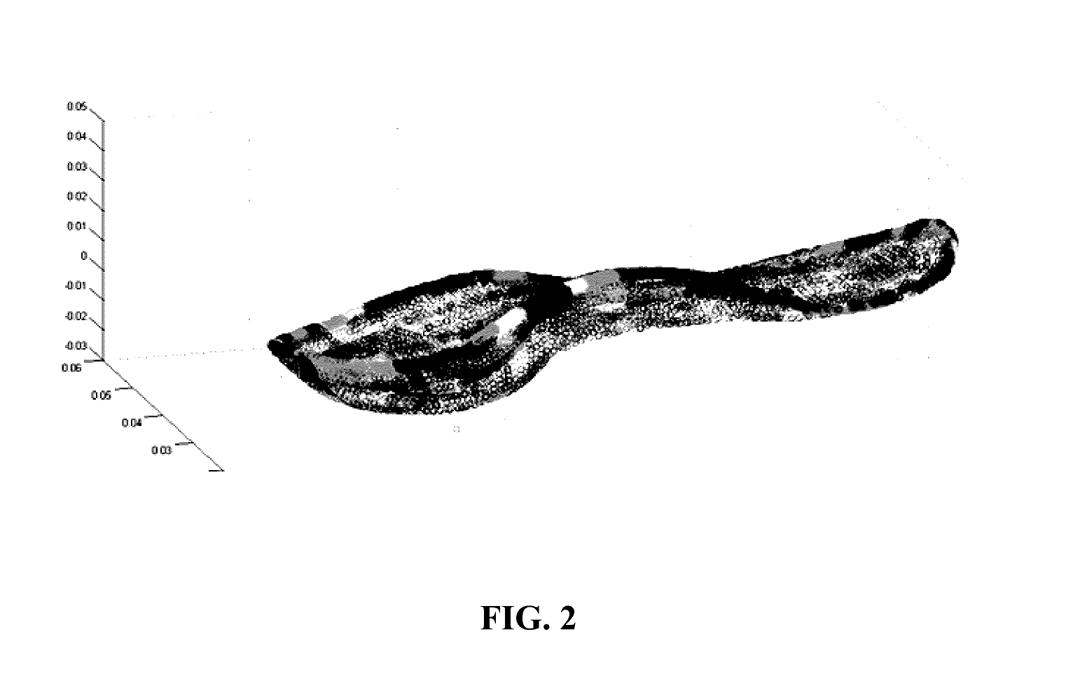

The 3D model of the orthotic can be imported into coding software and represented as a 3D array of x-, y-, and z-coordinates, as shown in FIG. 2. FIG. 2 is a schematic representing a 3D model of the generic orthotic that can be imported from 3D modeling system into coding software. In FIG. 2, the orthotic is represented as a series of points plotted in an x-, y-, and z-axis. To fit the orthotic custom to the individual, the generic orthotic can be scaled in the 2D x- and y-dimensions to fit the size of the patient's foot. One possible method for determining the size of the patient's foot is by extracting quantitative information about the width and length of the patient's foot based on their respective dynamic pressure. Using the x- and y-values from the dynamic pressure data of the patient, the maximum width of the forefoot, midfoot and hind foot during the various stances of gait can be determined. The length of the patients foot, as represented by the x- and y-coordinates of the pressure data, can be measured from the hind foot to the midfoot, from the midfoot to the forefoot, and from the hind foot to the forefoot. Using these parameters, the dimensions of the generic orthotic can be scaled to correspond to the individual.

According to some embodiments, the dimensions of the patient's foot for scaling purposes are determined using image analysis in coding software. By overlaying all the time frames of dynamic pressure during a single gait cycle, an outline of a patient's foot can be represented as a heat time frame image. Using coding software and image analysis tools, the outline dimensions of the foot can be determined. The generic orthotic model can then be scaled, in coding software, to the dimensions of the patient's foot.

According to some embodiments, modifications to the scaled orthotic model can be made by the user in coding software. Through a graphical user interface (GUI), the z-coordinates on the orthotic model can be changed by specifying the desired value. The GUI can include axes, pop-up menus, push buttons, slider bars, and edit text boxes, all of which can provide the user with a comprehensive selection of editing tools in order to customize the generic orthotic.

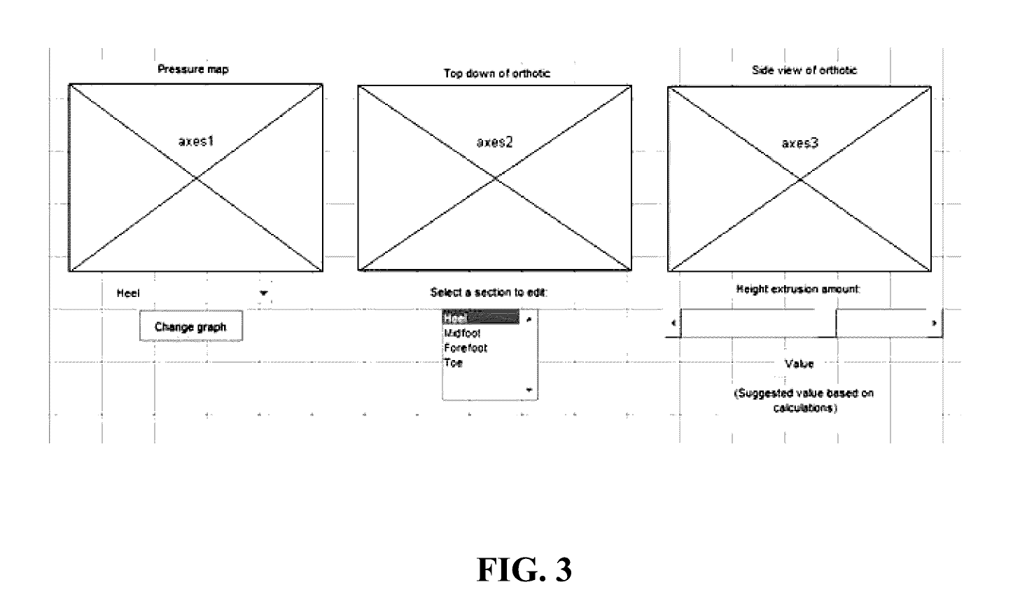

FIG. 3 shows a graphical user interface (GUI) that can be created in coding software. As shown in FIG. 3, the GUI include (from left to right): the pressure map data taken from the pressure mat with options of looking at the heel, midfoot, forefoot, toe, or an overlay of all the data; a top down view of the orthotic with the selected section highlighted (selections will include, but are not limited to: heel, midfoot, forefoot, and toe); and a side view of the orthotic for visualizing the amount of extrusion occurring, along with a suggested extrusion amount based on calculations done in a coding software.

The method described above provides a user-friendly interface in coding software to allow for the modeling of a custom orthotic. A graphical user interface (GUI) can be set up to provide the user with 3D representations of the orthotic at various angles of view. By providing the user with a graphical representation of the orthotic as customizations are being made, the user is able to monitor changes being made and verify that the correct modifications are being translated onto the orthotic at various steps of the process. This reduces the possibility of any errors being translated from the user to the system because they will be able to verify the changes and make necessary adjustments to the modifications to accurately depict the necessary measurements. Since the user will interact with the software by specifying numerical values through a thoroughly labeled graphical interface, minimal training is required for the user. The user is not required to be trained on how to modify a 3D model of the orthotic through modeling software, but rather will be required only to input desired values into specific menus on the interface. The system will input the user data to make the corresponding modifications to the orthotic.

This design approach allows for the customization of a generic orthotic by modifying the coordinates of the model directly in coding software. The user will be able to input a numeric data that represents the orthotic dimensions that is desired. For example, if a patient needs an orthotic with a heel post of a certain height, the user can specify the height input in the interface and the resulting z-coordinates of the generic orthotic heel will be modified to fit the desired height of the heel post. Modification of the generic orthotic using numeric coordinate representation provides precise orthotic dimensions. The user does not interface directly with the 3D model of the orthotic, which eliminates free-handed alterations to the dimensions based on a physical representation. Rather, this design allows for the translation of quantified data between the user and orthotic dimensions. By starting with a generic orthotic, there is reduced work for the user to create the custom orthotic. The features are present in the model and all that is required is modifying the dimensions of the orthotic.

This design approach is limited in its dependence to the design of custom orthotics from a generic orthotics. This design assumes that given a generic orthotic for a specific pathology (i.e. flatfoot), and variations in the dimensions of key features (i.e. hind foot post and arch height) produces customized orthotic. This design is limited in the degree of customization of the orthotics. By starting with a generic orthotic and modifying the features, there is a limitation in the degree of customization of the orthotic for the individual. All the orthotics produced by this system will have the same features, but the orthotic dimensions will be custom. Some pathologies of the foot, like arthritis, have little consistency of features between customized orthotics; other pathologies, like flatfoot, produce orthotics with similar features between individual products. Thus, this design can be limiting to the applications of orthotic fabrication to certain pathologies that produce orthotics with consistent features.

By scaling the generic orthotic to make the orthotic individualized to the patients foot shape, the resolution of the model of the orthotic will be altered. If the dimensions of the generic orthotic model is increased or decreased to scale to the dimensions of the patients foot, the resolution of the coordinates will be reduced or enhanced, respectively. When scaling the dimensions of the generic orthotic in a coding software, the number of coordinates that represent the orthotic model will remain the same and the distance between the coordinate points will be altered to accommodate the new dimensions. A lower resolution of orthotic coordinates in coding software may result in less defined orthotic features when the model is recreated in 3D modeling software. There will be limitations in the degree to which the dimensions of the orthotics can be scaled to ensure the resolution of the orthotic is sufficient to be 3D printed.

The orthotic model can be transferred between a coding software and 3D modeling software multiple times for the final orthotic output. Specifically, the 3D model of the scanned generic orthotic can be transferred to coding software, where modifications to the x-, y-, and z-coordinates can be made. This modified orthotic coordinate model can be transferred back into 3D modeling program as an array of coordinates in 3D space. The points can be meshed together to create a 3D solid model of the orthotic, which will be converted to a .stl file for 3D printing. Converting the model of the orthotic between different representations increases the possibility of deforming the orthotic model. Initially, converting a 3D model of a generic orthotic to a coordinate representation in coding software introduces possibility of data points being distorted or misaligned. This is further attributed to the intricate details of the generic orthotic model. The resolution of the orthotic present in the 3D model contains a large amount of coordinates that will be transferred into coding software. The higher resolution of data points being transferred between the 3D modeling and coding software increases the possibility in misrepresentation of orthotic model. To ensure that misrepresentation of the 3D generic model does not occur in coding software, a 3D graphical representation of the coordinate model in coding software can be constructed and compared to the 3D model of the orthotic in modeling software.

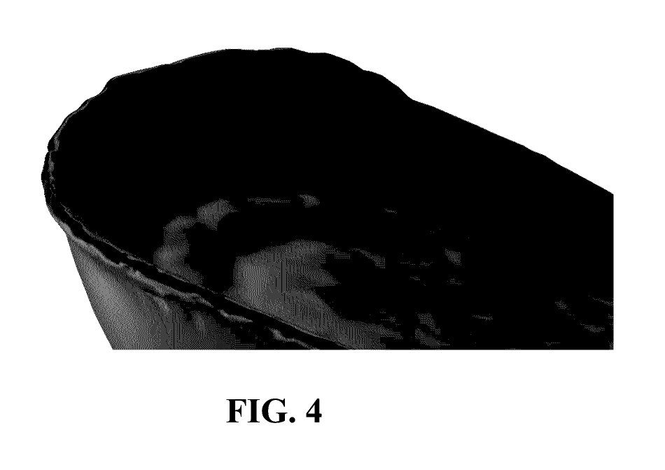

Scanning a generic model of the orthotic into modeling software can transfer rough surface details from the physical orthotic onto the 3D solid model of the orthotic. The surface features for orthotic model is shown in FIG. 4. As shown in FIG. 4, the rough surface features are transferred onto the 3D model when scanning an orthotic into modeling software resulting in high resolution surface features in the model. High surface feature resolution of the model will prevent the orthotic from being printed via 3D printing techniques. The 3D printing techniques restrict the resolution of features of the model to 20-200 microns. The model of the customized orthotic imported into modeling software can be further modified to smooth the features of the surface. This can be done in 3D modeling software, such as SolidWorks, in which the surface feature resolutions are reduced to the minimum resolution allowed for the model to be 3D printed. Additionally, further post-manufacturing processing of the orthotic may be used to further smooth the surface of the orthotic. For example, after the orthotic is 3D printed, the user can sand the surface of the orthotic to provide a smooth surface finish.

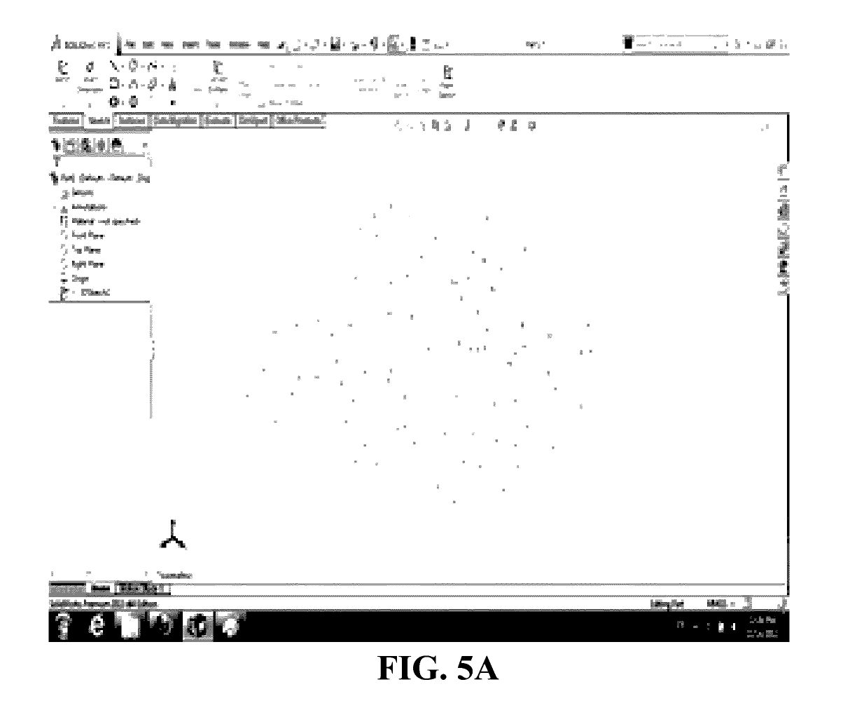

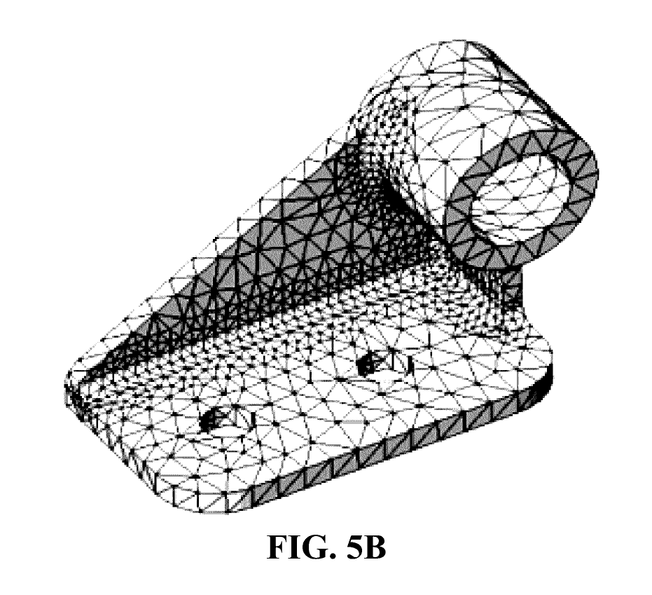

According to some embodiments, a method is provided which comprises making a model of the orthotic in coding software as an array of x-, y-, and z-data points and transferring the model into 3-D modeling software to be meshed into a solid. This method is illustrated in FIGS. 5A and 5B. As shown in FIGS. 5A and 5B, data transferred from coding software into 3-D modeling software appears in 3-D modeling software as points in 3-D space (FIG. 5A) which can be meshed into a solid (FIG. 5B). The meshing process requires 3-D modeling software to “connect the dots” forming a solid model. Data collected from the pressure mat can be used to constrain the final model. Specific frames of data such as the heel strike, mid-stance, heel off, and toe off can be used to determine the final shape of the orthotic model. These frames can be saved and exported (e.g., as a Microsoft Excel® file) which can be manipulated in coding software. Once the data is imported into the coding software, it can appear as a 2-D footprint of the four frames of the foot. With these frames, the user can manipulate the data in order to combine the frames into a solid model, which can be used as the bases for the orthotic. The four frames of the foot that form the orthotic can be used to separate the orthotic into four regions for further manipulation. These data points can then be transferred into 3-D modeling software's 3-D space.

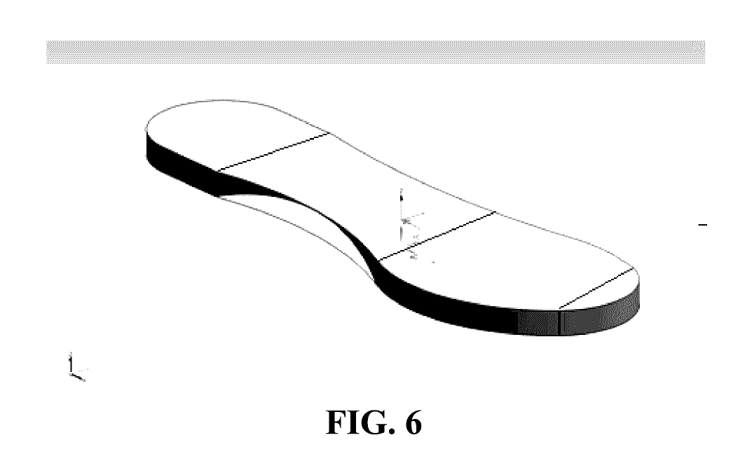

The data will be separated into three sections representing each dimension in 3D space: x, y, and z. The x and y data can be used to create a 2-D outline of the orthotic model. The z data can be used to determine the distance the model is to be “extruded” into the 3^{rd} or thickness dimension. Once the data points are in 3-D modeling software and meshed into a solid, the model can appear as four basic shapes as shown in FIG. 6. This will allow the clinician to modify the model to fit the patient. In order for the orthotic to be customized, the clinician will have full control in modifying the model. The 3D modeling software will allow the user to fully customize the model to their liking. The clinician will be able to extrude any section of the orthotic in order to match the patient's pathology. The edges can also be rounded (i.e., fillet) and smoothened by the user in order to maximize comfort for the patients as well as match the foot of the patient.

The method described above which involves making a model of the orthotic in coding software is user friendly and simple to implement because the data that is analyzed can be converted directly into the orthotic outline and only requires the model to be meshed and customized before it is printed. This approach eliminates the constant transfer of data between programs which can be problematic due to conversion of the files which can result in either deleted or altered data and an inaccurate model. This method also produces orthotics which are very patient-specific because it is starting from the pressure data collected from the patient and constructed directly from those data points. It also allows the clinician to make any extra modifications they deem necessary in order to maximize the comfort for the patient. Since all of the data used for making the model comes from the patient, the need for the clinician to measure the patient's foot is eliminated.

3-D modeling software is user friendly. For example, making an extrusion involves choosing the extrusion command, selecting the area that the user wants to extrude, and dragging the area up to the desired height. Filleting the edges of the model can require merely selecting the edges, pressing the fillet command, and deciding the radius of the edges. According to some embodiments, extrusion and fillet are the only commands used to modify the model.

Making a model of the orthotic in coding software requires user input. If the clinician adjusts the model dimensions poorly, the final product will not be beneficial for the patient. Accordingly, the modelling parameters can be determined directly from the pressure data thereby creating a fully automated system.

The orthotic can be manufactured using an automated manufacturing process. Exemplary and non-limiting examples of suitable manufacturing processes include CNC routing and 3D printing. 3D printing is an additive manufacturing technique that is used to create solid objects from a digital file. After a model is made in Computer Aided Design (CAD) software, it is automatically sliced into many planar layers by the software. This is then uploaded to the 3D printer as a Stereolithography (.stl) file, which creates the object one layer at a time. There are several methods of adding layers, but because there is no need for super high resolution, fused deposition modeling (FDM) is the best technique. FDM uses a polymer filament or metal wire that supplies material to an extrusion nozzle, which heats the material and controls flow. The melted material is used to form layers, which harden immediately after being applied.

The biggest benefit of 3D printing using FDM is its ability to create complex geometries relatively quickly. There are very few constraints, as a 3D printer can make anything created in CAD. Because the process is mostly automated, there is no need for highly skilled workers. Another advantage is that there is limited material waste because this is an additive process [19]. FDM 3D printers have become significantly cheaper and there are now many models that cost less than $500 [20]. 3D printing is limited by the poor mechanical properties, as 3D printed objects tend to be weak at the joints and can fracture along layers [21]. There is also a limit on the number of materials that are compatible with the printer, and FDM can only print using polymers and metals; however, the materials used for orthotic fabrication are compatible with 3D printers, and are therefore not a limitation.

According to some embodiments, the dimensions of the pressure mat are at least 40 cm by 15 cm. Exemplary and non-limiting material that can be used to manufacture the orthotic include, but are not limited to, polypropylene, ethylene-vinyl acetate (EVA), acrylonitrile butadiene styrene (ABS), and polychloroprene. According to some embodiments, the 3D printer used to manufacture the orthotics is able to print two materials simultaneously and has a building envelope that is at least 35 cm by 12 cm by 2 cm.

According to some embodiments, a method is provided which comprises: creating a “normal” standard foot model using a sufficient number of people (e.g., 1000) without foot pathologies; determining parameters for common foot pathologies; determining a relationship between each pathology and the degree of change in the orthotic dimensions; translating the relationship into coding software; exporting an orthotic model from the coding software to modeling software; and sending data from the modeling software to a 3D printer. Foot pathologies for which parameters can be determined include, but are not limited to, flatfoot, cavus foot, 2^{nd} metatarsalgia, metatarsalgia, toe walking, foot and gait abnormalities resulting from diabetes, and foot deformities resulting from failed surgery.

According to some embodiments, systems and methods are provided which comprise one or more of the following features/characteristics:

1) Record pressure monitoring of a patients limb/foot and model it in a 3-dimensional format.

2) Allow for an interface with the practitioner to model an orthotic insert to appropriately fit and address the underlying medical condition.

3) Allow for the modelling software to use automation to model the orthotic based off of the data accrued from #1.

4) Create an output file to render a 3d printed medical device from the data accrued in #1 and the modelling input from #2 and #3.

5) Allow for real time monitoring of pressure by providing the orthotic with pressure sensors that can measure pressure over the course of the gait cycle.

6) Qualitatively measure pressure over the course of time as the orthotic is being worn by the patient.

7) Quantitatively measure pressure over the course of time as the orthotic is being worn by the patient.

8) Store the data with respect to #6 and #7 in a cloud based format.

9) Notify the person wearing the device of the data in #6 and #7 as predefined by a practitioner.

10) Notify the practitioner of all data in #6 and #7.

11) Data can be transmitted wirelessly. Notification can be, for example, via Bluetooth, WiFi, and/or via personal smartphone application.

12) Track pressure in real time in order to monitor cumulative pressure over the course of time.

13) Transmit feedback to patient from #12 in order to assure patient is not experiencing momentary or cumulative pressure overload.

14) Transmit feedback to practitioner from #12 in order to assure patient is not experiencing momentary or cumulative pressure overload.

While the foregoing specification teaches the principles of the present invention, with examples provided for the purpose of illustration, it will be appreciated by one skilled in the art from reading this disclosure that various changes in form and detail can be made without departing from the true scope of the invention.

### REFERENCES

[1] http://www.apma.org/Media/PRdetail.cfm?ItemNumber=13075, accessed Feb. 25, 2015.
[2] Warren C, Tom A E. A Review of the Pathophysiology, Classification, and Treatment of foot Ulcers in Diabetic Patients. Clinical Diabetes, 2009; 2: 52-58.
[3] http://www.aofas.org/footcaremd/treatments/Pages/Orthotics.aspx, accessed Feb. 25, 2015.
[4] http://orthoinfo.aaos.org/topic.cfm?topic=A00146 accessed Feb. 25, 2015.
[5] Riegger, C L. Anatomy of the Ankle and Foot (1988): 1-15. Physical Therapy. American Physical Therapy Association. Web. 16 Mar. 2015.
[6] Michael S L, John V V, James L T, Alan R C, Geza K, Steven R K, Stephen J M, Susan C G. Diagnosis and Treatment of Adult Flatfoot. Foot&Ankle Surgery, 2005; 44:78-113.
[7] http://www.ncbi.nlm.nih.gov/pubmed/14560896 accessed Mar. 16, 2015.
[8] http://www.footmapping.ca/measurment_system.html accessed Feb. 25, 2015.
[9] Miller J K, Latterman M S, Latterman S A. “Foot Orthotic Devices.” United States Patent application US 2009/8109014 B2 filed January, 2009.
[10] http://www.businesswire.com/news/home/20110719006061/en/DJO-Incorporated-Leads-Global-Market-Orthotics-Prosthetics#.VSHEsfnF-dN, accessed Apr. 4, 2015.
[11] http://www.prweb.com/pdfdownload/8061575.pdf, accessed Apr. 4, 2015.
[12] http://www.afootprint.eu/about/objectives/, accessed Apr. 4, 2015.
[13] http://www.healio.com/orthotics-prosthetics/industry-news/news/print/o-and-p-news/%7Bc2d04446-465a-4c7d-944b-21fd57603547%7D/new-report-offers-global-projections-for-orthopedic-prosthetic-and-orthotic-markets, accessed Apr. 4, 2015.
[14] http://www.researchandmarkets.com/research/dq9bz6/global_orthotic, accessed Apr. 4, 2015.
[15] http://www.afootprint.eu/about/a-footprintvideos/, accessed Apr. 4, 2015.
[16] http://www.afootprint.eu/about/expectedresults/, accessed Apr. 4, 2015.
[17] http://www.nytimes.com/2006/06/22/fashion/thursdaystyles/22Fitness.html?pagewanted=print&_r=0 accessed Mar. 15, 2015.
[18] http://3dprinting.com/what-is-3d-printing/, accessed Apr. 1, 2015.
[19] http://compositesmanufacturingmagazine.com/2014/10/pros-cons-additive-manufacturing/, accessed on Apr. 1, 2015.
[20] http://www.digitaltrends.com/cool-tech/tiko-3d-printer/, accessed Apr. 1, 2015.
[21] http://www.designworldonline.com/subtractive-vs-additive-prototyping/, accessed Apr. 1, 2015.
[22] http://www.cncroutersource.com/cnc-wood-router.html, accessed Apr. 1, 2015.
[23] http://www.solutionsforwood.com/docs/reports/UnderstandingCNCRouters.pdf, accessed Apr. 1, 2015.

What is claimed is:

1. A method of manufacturing a custom foot orthotic for a patient comprising:
collecting dynamic pressure data of a plantar surface of the foot of the patient, wherein the dynamic pressure data includes pressure data taken at multiple time frames during a gait cycle of the patient;
creating a three-dimensional model of a foot orthotic, wherein the foot orthotic has a length, a width and a height and wherein the three-dimensional model comprises an x-axis extending along the length of the foot orthotic, a y-axis perpendicular to the x-axis and extending along the width of the foot orthotic and a z-axis perpendicular to the plane formed by the x and y axes and extending along a thickness of the foot orthotic;
determining the dimensions of the patient's foot from the dynamic pressure data;
scaling the three dimensional model along the x and y axes to form a scaled three dimensional model which approximates the dimensions of the patient's foot; and
adjusting the height of the scaled model along the z-axis in one or more regions based on the dynamic pressure data to form a three-dimensional model of the custom foot orthotic.

2. The method of claim 1, wherein the data is collected while the patient is walking.

3. The method of claim 1, wherein the dimensions of the patient's foot are determined from the dynamic pressure data at a single time frame.

4. The method of claim 1, wherein the dimensions of the patient's foot are determined by:
overlaying a plurality of time frames of the dynamic pressure data during a single gait cycle;
representing an outline of the patient's foot as a heat time frame image; and
determining the dimensions of the patients foot from the heat time frame image.

5. The method of claim 1, wherein the one or more regions comprise: a heel region; a midfoot region; a forefoot region and a toe region.

6. The method of claim 1, wherein scaling the three dimensional model along the x and y axes and adjusting the height of the scaled model along the z-axis in one or more regions is performed using programming software.

7. The method of claim 6, wherein the programming software comprises a graphical user interface adapted to display: a pressure map of the dynamic pressure data; a top down view of the orthotic showing the x and y dimensions; and a side view of the orthotic showing the z-dimension.

8. The method of claim 1, wherein scaling the three dimensional model in the x and y axes comprises scaling the x and y axes independently.

9. The method of claim 6, wherein the graphical user interface is adapted to display a pressure map of the dynamic pressure data in one or more regions of the foot.

10. The method of claim 1, further comprising manufacturing the custom foot orthotic from the three-dimensional model of the custom foot orthotic.

11. The method of claim 10, wherein manufacturing the custom foot orthotic comprises 3D printing.

12. The method of claim 1, wherein creating a three-dimensional model of a foot orthotic comprises three-dimensional scanning of the foot orthotic.

13. The method of claim 1, wherein the multiple time frames during the gait cycle comprise heel strike, mid-stance, heel off and toe off.

14. A method of manufacturing a custom foot orthotic for a patient comprising:
collecting dynamic pressure data of a plantar surface of the foot of the patient, wherein the dynamic pressure data includes pressure data taken at multiple time frames during a gait cycle of the patient;
creating a two-dimensional model of the custom foot orthotic from the dynamic pressure data, wherein the foot orthotic has a length, a width and a height and wherein the two-dimensional model comprises an x-axis extending along the length of the foot orthotic and a y-axis perpendicular to the x-axis and extending along the width of the foot orthotic;
converting the two-dimensional model into a three dimensional model by extruding one or more regions of the two-dimensional model along a z-axis perpendicular to the plane formed by the x and y axes and extending along a thickness of the foot orthotic based on the dynamic pressure data to form a three-dimensional model of the custom foot orthotic.

15. The method of claim 14, wherein the data is collected while the patient is walking.

16. The method of claim 14, wherein the one or more regions comprise: a heel region; a midfoot region; a forefoot region and a toe region.

17. The method of claim 14, further comprising manufacturing the custom foot orthotic from the three-dimensional model of the custom foot orthotic.

18. The method of claim 17, wherein manufacturing the custom foot orthotic comprises 3D printing.

19. A system for manufacturing a custom foot orthotic for a patient comprising:
a pressure mat adapted to measure dynamic pressure of a plantar surface of a foot of the patient, wherein the dynamic pressure data includes pressure data taken at multiple time frames during a gait cycle of the patient; and
a computer adapted to:
access a three dimensional model of a foot orthotic, wherein the foot orthotic has a length, a width and a height and wherein the three-dimensional model comprises an x-axis extending along the length of the foot orthotic, a y-axis perpendicular to the x-axis and extending along the width of the foot orthotic and a z-axis perpendicular to the plane formed by the x and y axes and extending along a thickness of the foot orthotic;
determine the dimensions of the patient's foot from the dynamic pressure data;
scale the three dimensional model of the foot orthotic along the x and y axes to form a scaled three dimensional model which approximates the dimensions of the patient's foot; and
adjust the height of the scaled model along the z-axis in one or more regions.

20. The system of claim 19, further comprising a 3D printer adapted to manufacture the custom orthotic from the three-dimensional model of the custom foot orthotic.

21. The system of claim 19, wherein the computer is adapted to adjust the height of the scaled model along the z-axis in one or more regions based on user inputs.

22. A system for manufacturing a custom foot orthotic for a patient comprising:
a pressure mat adapted to measure dynamic pressure of a plantar surface of a foot of the patient, wherein the dynamic pressure data includes pressure data taken at multiple time frames during a gait cycle of the patient; and
a computer adapted to:
collect dynamic pressure data from the pressure mat, generate a two-dimensional model of a foot orthotic from the pressure data, wherein the foot orthotic has a length, a width and a height and wherein the two-dimensional model comprises an x-axis extending along the length of the foot orthotic and a y-axis perpendicular to the x-axis and extending along the width of the foot orthotic;
convert the two-dimensional model into a three dimensional model by extruding one or more regions of the two-dimensional model along a z-axis perpendicular to the plane formed by the x and y axes and extending along a thickness of the foot orthotic based on the dynamic pressure data to form a three-dimensional model of the custom foot orthotic.

23. The system of claim 22, further comprising a 3D printer adapted to manufacture the custom orthotic from the three-dimensional model of the custom foot orthotic

24. The system of claim 22, wherein the computer is adapted to convert the two-dimensional model into a three dimensional model based on user inputs.

25. The system of claim 22, wherein the computer is adapted to convert the two-dimensional model into a three dimensional model automatically based on the dynamic pressure data.
